(19) United States
(12) Patent Application Publication
(10) Pub. No.: US 2026/0022982 A1
(43) Pub. Date: Jan. 22, 2026

(54) KEYBOARD TOUCH MEASURING DEVICE, SYSTEM, AND METHOD

(71) Applicants: Skyler Guest, San Marcos, TX (US); OA Watson, San Marcos, TX (US)

(72) Inventors: Skyler Guest, San Marcos, TX (US); OA Watson, San Marcos, TX (US)

(21) Appl. No.: 19/272,464

(22) Filed: Jul. 17, 2025

Related U.S. Application Data
(60) Provisional application No. 63/673,118, filed on Jul. 18, 2024.

(51) Int. Cl. G01L 5/00; G10C 3/12; G10C 3/16; G10C 9/00

(52) U.S. Cl. CPC G01L 5/0038; G01L 5/0033; G10C 3/12; G10C 3/16; G10C 9/00

(57) ABSTRACT

The present disclosure provides a key measuring device for measuring the touchweight parameters of one or more keys of a keyboard instrument, such as a piano. The key measuring device may include a plunger configured to contact a top surface of a key and move in a direction substantially perpendicular to said top surface and a force sensor coupled to the plunger and configured to provide an output signal indicative of the force between the plunger and the top surface of the key. Also provided are systems and methods for measuring touchweight parameters of a key.

### BACKGROUND

Action in a piano or other keyboard instrument is a mechanical assembly that translates depression of the keys to sound. In an acoustic instrument, such as a piano, the action translates the depression of a key into the motion of a hammer that strikes strings to create sound. The touchweight of a key is a measure of the force that is required to depress the key. An action may be described as light when little pressure is required to depress the key and heavy when more force is required. The keys in electric keyboards, such as digital pianos, may be weighted to replicate the feel of the action of an acoustic instrument.

The action and associated touchweights are key determinants of how it feels to play a particular instrument. Accordingly, instrument manufacturers and technicians tune the touchweights of a particular key by adding, or subtracting, small lead weights to the key. In addition, an individual musician may wish to tune the touchweight of the keys of a keyboard to suit their preferences and playing style.

Typically, touchweight is measured by placing small weights on a key to determine the amount of weight necessary to depress a key (typically referred to as “downweight”) and the amount of weight the key will lift from its depressed position (typically referred to as “upweight”). This method, however, is time consuming, imprecise, and prone to user error.

### BRIEF DESCRIPTION OF THE DRAWINGS

FIGS. 1A-1C show front (A), top (B), and side (C) views of an exemplary key measuring device of the present disclosure.

FIG. 2 shows an exemplary display for a key measuring device of the present disclosure.

FIG. 3 shows a cutaway side view of an exemplary key measuring device of the present disclosure.

FIG. 4 shows an exemplary key measuring device of the present disclosure in position to measure the touchweight of a key on a piano keyboard.

FIGS. 5-7 show views of an exemplary interface and display of the present disclosure.

### DETAILED DESCRIPTION

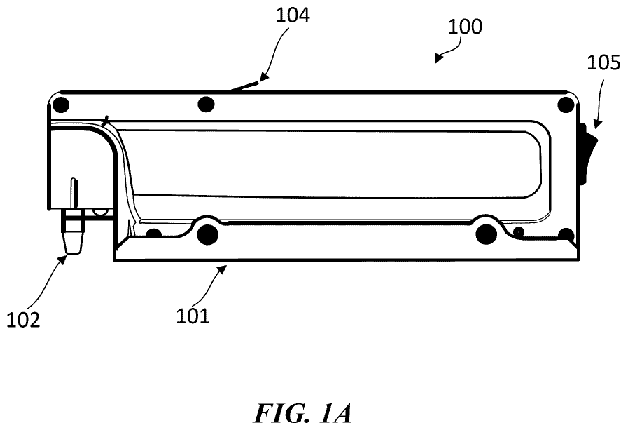

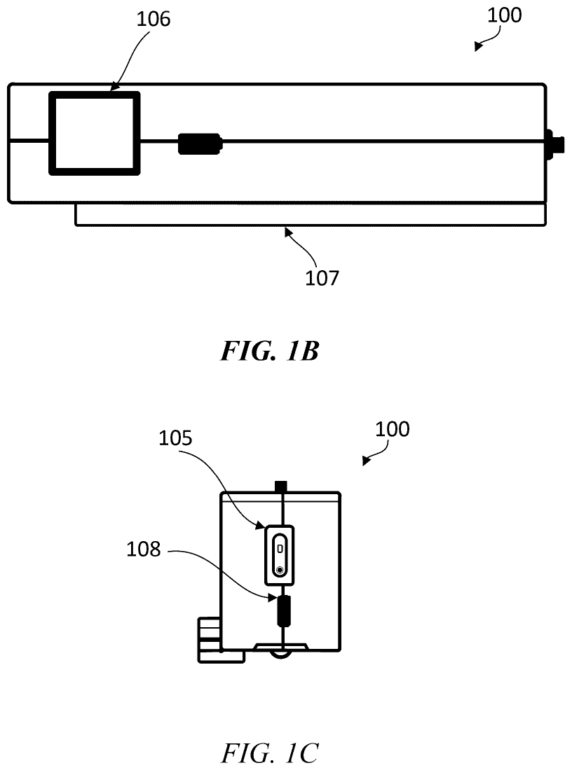

The present disclosure provides a key measuring device for measuring touchweight parameters for a key on a keyboard instrument, such as a piano. Touchweight parameters may include downweight, upweight, balance weight, friction, and key dip. FIGS. 1A, 1B, and 1C show front, top, and side views, respectively, of an exemplary key measuring device 100 according to the present disclosure. The key measuring device may include a bottom surface 101 that is substantially flat and configured to rest on the top surface of one or more keys adjacent to the key being measured. In some embodiments, the key measuring device is of a weight sufficient that it is not displaced during operation of the device. In some embodiments, the key measuring device is of sufficient weight that the keys it rests upon remain in a depressed position during the operation of the device. In some embodiments, the bottom surface is covered with a material such as fabric, leather, vinyl, rubber, and the like to protect the surface of the keys. In some embodiments, the material of the bottom surface 101 is selected to provide a non-slip surface such to reduce the likelihood that the device will move during operation.

The key measuring device of the present disclosure may also include a plunger 102 that is configured to contact the top surface of the key being measured during operation of the key measuring device. The plunger 102 may be configured to move in a substantially vertical direction such that it may move with the key throughout its range of motion. In some embodiments, the plunger 102 is coupled to a motor such that it may be moved in a controlled fashion to depress and release the key being measured through a desired range of motion. In some embodiments the plunger is coupled to a force sensor that is configured to provide an output signal indicative of the force between the plunger and the top surface of the key at one or more key positions as the key is depressed and/or returned. In some embodiments, upon activation of the device, the plunger moves downward at a substantially constant speed to move the key from a neutral position to a fully depressed position and then upwards to allow the key to return to a neutral position. The force exerted by the plunger on the key may be measured at predetermined points along the path. In some embodiments the force exerted by the plunger on the key is measured in a substantially continuous manner as the key is depressed and returned.

The key measuring device may include an activating switch 104 to allow the device to be activated once placed in the desired position. In some embodiments, the key measuring device includes a power switch 105 and a port 108. Port 108 may be a USB or similar port that allows for connecting the device to a power source to power the device and/or to charge an internal battery. In some embodiments, port 108 allows the device to be connected to a computer, tablet, mobile phone, or other similar computing device that allows for the storage, processing, and display of information collected by the measuring device. In some embodiments, port 108 allows for data, software, and/or firmware to be uploaded to the key measuring device.

In some embodiments, the key measuring device includes an alignment surface 107 that provides a front facing surface that may be aligned with the front of the keys upon which the device rests to ensure consistent placement of the device. As illustrated in FIGS. 1B and 1C, the alignment surface 107 may extend beyond the other front-facing surfaces of the device. In some embodiments, the degree to which the alignment surface 107 extends is adjustable to allow a user of the device to assess the touchweight of a key at a desired distance from the front of the key.

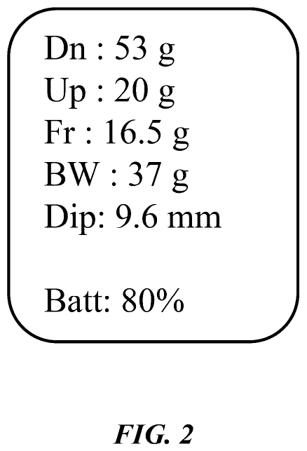

In some embodiments, the key measuring device includes a display 106 for presenting information to the user. Display 106 may, for example, present relevant measurement data to the user such as downweight, upweight, balance weight, friction, and key dip. Display 106 may also be configured to present status indicators to the user. Status indicators may include remaining battery charge, an indication that the device is in operation, error messages, or any additional information that may be helpful to the user. FIG. 2 shows an exemplary display showing the results of the measurement of a key. In this exemplary embodiment the display shows downweight (designated “Dn”), upweight (designated “Up”), friction (designated “Fr”), balance weight (designated “BW”), key dip (designated “Dip”), and the percentage of battery charge remaining (designated “Batt”).

Downweight may be assessed based on the force measured as plunger 102 depresses the key. Downweight may be assessed based on the force measured at one or more specified positions, the maximum force measured, or the force measured over the keystroke, or a portion thereof, as the key is depressed. In some embodiments, the downweight is calculated based on multiple measurements and may be presented, for example, as the maximum, minimum, mean, median, or other combination of such measurements. In some embodiments, the downweight is presented with a measurement of the extent that the measurements vary, such as a standard deviation, range, or the like.

Upweight may be assessed based on the force measured as plunger 102 is raised and the key moves from a depressed position to a neutral position. Upweight may be assessed based on the force measured at one or more specified positions, the maximum force measured, or the force measured over the keystroke, or a portion thereof, as the key moves from a depressed position to the neutral position. In some embodiments, the upweight is calculated based on multiple measurements and may be presented, for example, as the maximum, minimum, mean, median, or other combination of such measurements. In some embodiments, the upweight is presented with a measurement of the extent that the measurements vary, such as a standard deviation, range, or the like.

Friction may be estimated by calculating the difference between the downweight and the upweight and dividing that value by two. The balance weight may be calculated by taking the average of the upweight and the downweight.

Key position is a measure of the amount a key has been displaced from its neutral position—the position of the key at rest. Key position is typically measured as the distance in millimeters between the top surface of a depressed, or partially depressed, key and the top surface of the key in neutral position. Key dip may be calculated by measuring the vertical displacement of the plunger necessary to move the key from the neutral position to a fully depressed position.

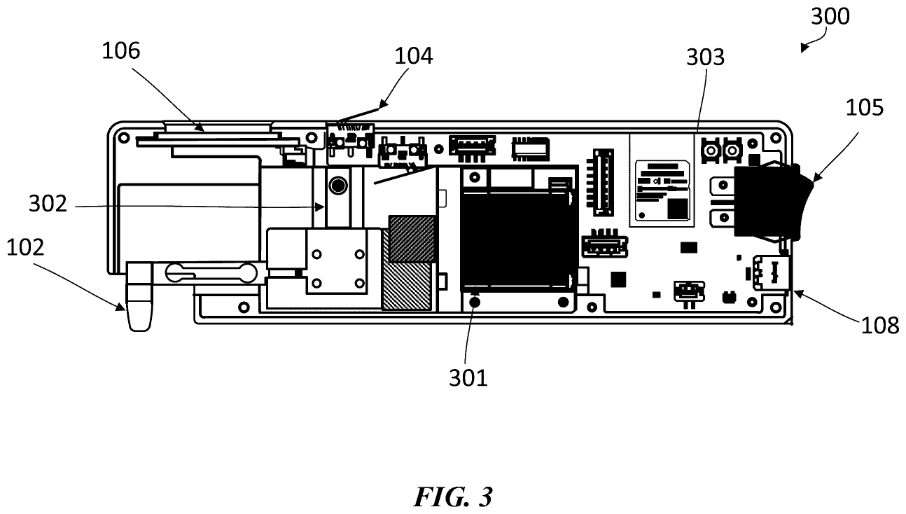

FIG. 3 shows a cutaway view of an exemplary key measuring device 300 according to the present disclosure. Plunger 102, activating switch 104, power switch 105, display 106, and port 108 may operate substantially as described above. In exemplary embodiments, the key measuring device includes a motor 301. Motor 301 may be a stepper motor or other dc motor that allows for positioning of the plunger with the desired precision. Plunger 102 may be coupled to linear profile rail 302 such that its path is limited to a substantially vertical direction.

In some embodiments, the key measuring device of the present disclosure includes a processing module configured to control the motor and receive an output signal from the force sensor coupled to plunger 102. In some embodiments, the processing module of the key measuring device includes a printed circuit board (PCB) 303. PCB 303 may include memory for storing firmware and associated information necessary for operating the device as well as storing data collected from the device. PCB 303 may also include a processor for processing data and executing firmware commands.

In some embodiments, key measuring device 300 includes a rechargeable battery, such as a lithium-ion battery, for powering the device. In other embodiments, the device is configured to receive alkaline batteries or to be powered from an external power source.

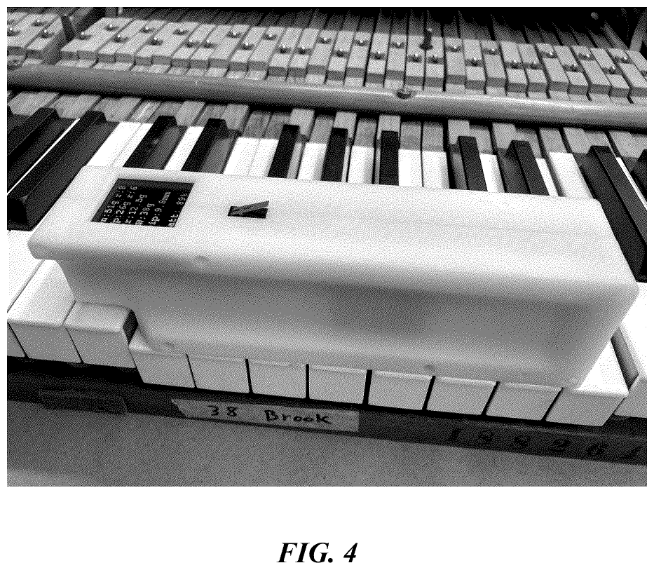

In some embodiments the key measuring device is portable. In some embodiments, it is of a size and weight that it may be placed in a bag or toolbox and carried from place to place. As illustrated in FIG. 4, in some embodiments the key measuring device may be placed directly on a keyboard such that it rests on keys adjacent to the key being assessed and the plunger is placed above the key being assessed.

In some embodiments, a key measuring device according to the present disclosure is configured to enable communication over a wired or wireless network. In some embodiments, the network is a wireless network, such as a Wi-Fi, Bluetooth, or cellular network. In some embodiments, the key measuring device is configured to communicate over a network with an external computation device such as a network server, desktop computer, laptop, tablet, mobile phone, and the like.

In some embodiments, the external computation device is configured to issue commands to the key measuring device. Such commands may include instructions to activate the device, power the device on or off, or perform diagnostic assessments of the device. In some embodiments, such commands may specify parameters to be used by the device in assessing touchweight of a key. For example, such parameters may specify the values to be used in calculating downweight or upweight or to specify that an alert is to be provided is a measurement exceeds a threshold value.

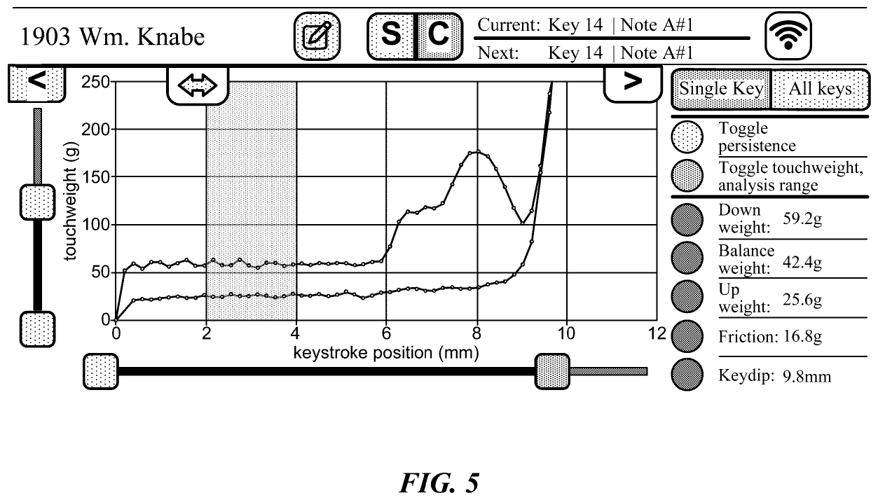

In some embodiments, the external computation device is configured to provide an interface and display for presenting and interacting with data provided by the key measuring device of the present disclosure. An exemplary interface and display is illustrated in FIG. 5. In this example, exemplary data is illustrated for key 14 of an exemplary piano keyboard. Calculated values of downweight, balance weight, upweight, friction, and key dip are presented along the right of the display. Presented in the center of the display are plots showing the measured touchweight at specified keystroke positions for a downstroke (upper plot) and an upstroke (lower plot). The x-axis presents the key position in millimeters (mm) and the y-axis presents the measured touchweight in grams (g). The range between a key position of 2 mm and 4 mm is highlighted to indicate that this range has been selected for analysis of touchweight as presented in the calculated values for downweight, balance weight, upweight, and friction.

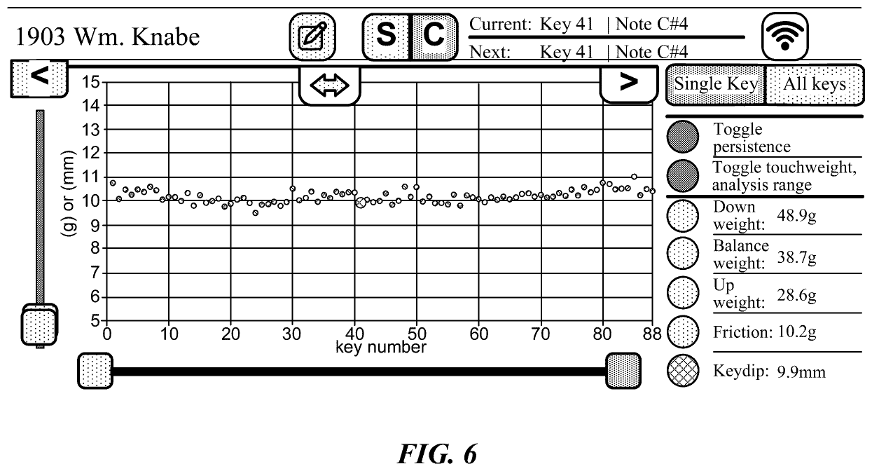

FIG. 6 shows an additional view of an exemplary interface and display. The key measuring device of the present disclosure may be used to measure two or more keys and the data collected may be stored in the key measuring device and/or an external computation device. The data for each key may subsequently be presented at the request of a user. The exemplary interface and display shown in FIG. 5 presents the measured key dip for each of the 88 keys of a piano keyboard. The x-axis presents the key number and the y-axis presents the key dip in millimeters. The display may be configured to present, in a similar manner, values of downweight, balance weight, upweight, or friction for each key.

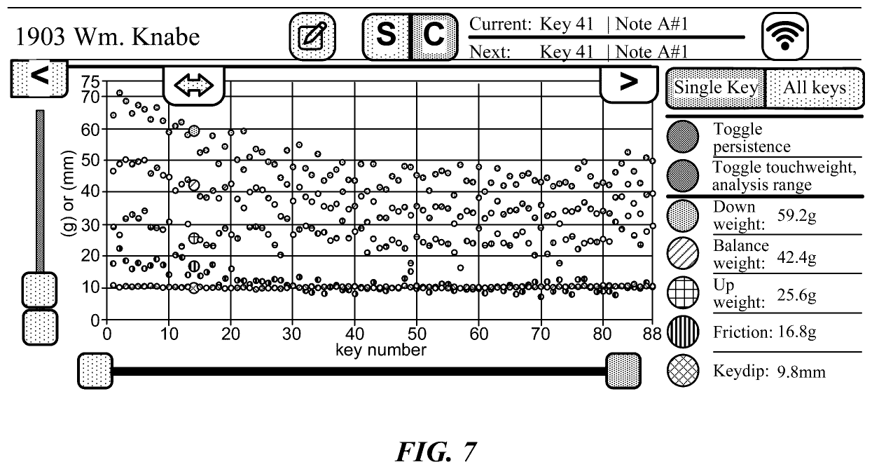

FIG. 7 shows an additional view of an exemplary interface and display. In this example, the downweight, balance weight, upweight, friction, and key dip are presented for each of the 88 keys of a piano keyboard. The x-axis presents the key number and the y-axis presents the values in grams or millimeters. The display may be color coded to allow for the different values to be more readily distinguished.

In some embodiments, the key measuring device or external computation device of the present disclosure may be configured to identify measured values that exceed or fall below specified threshold values. Such threshold values may be specified by the user or calculated based on measured values for other keys in the keyboard. In some embodiments, the key measuring device or external computation device of the present disclosure may be configured to calculate and present the magnitude of a correction that may be made to bring the touchweight of a key to a desired value. For example, if the balance weight of a key has a value that exceeds a threshold, the interface may be configured to identify the key to the user along with the amount of weight that may be added to the key to bring the balance weight within the desired range.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A key measuring device, comprising:
a) a plunger configured to contact a top surface of a key and move in a direction substantially perpendicular to said top surface;
b) a motor coupled to the plunger and configured to move the plunger in a controlled manner;
c) a force sensor coupled to the plunger and configured to provide an output signal indicative of the force between the plunger and the top surface of the key; and
d) a processing module configured to control the motor and receive the output signal from the force sensor.

2. The key measuring device of claim 1, wherein the processing module is configured to determine one or more touchweight parameters of the key to be measured.

3. The key measuring device of claim 2, wherein the one or more touchweight parameters are selected from one or more of downweight, upweight, balance weight, friction and key dip.

4. The key measuring device of claim 2, comprising a display configured to show one or more touchweight parameters of the key and/or one or more status indicators for the key measuring device.

5. The key measuring device of claim 1, wherein, upon activation of the device, the plunger is configured to move downward at a substantially constant rate to fully depress the key and then to move upward at a substantially constant speed to allow the key to return to its neutral position.

6. The key measuring device of claim 1, wherein the key measuring device is portable.

7. The key measuring device of claim 6, comprising a bottom surface that is substantially flat and configured to rest on the top surface of one or more keys adjacent to the key of claim 1(a).

8. The key measuring device of claim 7, comprising a front facing surface that may be aligned with the front of the one or more keys adjacent to the key of claim 1(a).

9. A system comprising the key measuring device claim 1, a computation device, and a network configured to allow communication between the key measuring device and the computation device.

10. The system of claim 9, wherein the computation device is a handheld device selected from a tablet and a mobile phone.

11. The system of claim 10, wherein the network is a wireless network.

12. The system of claim 11, wherein the wireless network is a Wi-Fi network or a Bluetooth network.

13. The system of claim 11, wherein the computation device is configured to send instructions to the key measuring device over the network.

14. The system of claim 9, wherein the computation device is configured to receive one or more touchweight parameters from the key measuring device and store the one or more touchweight parameters in a memory module.

15. The system of claim 14, wherein the one or more touchweight parameters are selected from downweight, upweight, balance weight, friction and key dip.

16. The system of claim 15, wherein the computation device is configured to provide a user interface and to display the one or more touchweight parameters.

17. A method of measuring one or more touchweight parameters of a key, comprising:
a) providing a plunger configured to contact a top surface of the key and move in a direction substantially perpendicular to said top surface;
b) providing a force sensor coupled to the plunger and configured to provide an output signal indicative of the force between the plunger and the top surface of the key;
c) moving the plunger downward at a substantially constant rate to depress the key from a neutral position to a depressed position;
e) receiving the output signal of the force sensor at a key position between the neutral position and the depressed position while the plunger is moving downward; and
f) determining the one or more touchweight parameters based on the output signal received in step (e).

18. The method of claim 17, further comprising:
g) moving the plunger upward at a substantially constant speed to allow the key to return from the depressed position to the neutral position;
h) receiving the output signal of the force sensor at a key position between the depressed position and the neutral position while the plunger is moving upward; and
i) determining the one or more touchweight parameters based on the output signal received in step (h).

19. The method of claim 17, wherein the one or more touchweight parameters are selected from downweight, upweight, balance weight, friction and key dip.

20. The method of claim 18, wherein the one or more touchweight parameters are selected from downweight, upweight, balance weight, friction and key dip.
